(19) United States
(12) Patent Application Publication
(10) Pub. No.: US 2026/0348612 A1
(43) Pub. Date: Nov. 5, 2026

(54) UNIVERSAL VENT COVER

(71) Applicant: Evan S. Greenberg, Lake Hopatcong, NJ (US)

(72) Inventor: Evan S. Greenberg, Lake Hopatcong, NJ (US)

(21) Appl. No.: 19/197,111

(22) Filed: May 2, 2025

(51) Int. Cl. F24F 13/08; A01M 29/34; D06F 58/20; F24F 7/00; F24F 7/04

(52) U.S. Cl. CPC F24F 13/082; A01M 29/34; D06F 58/20; F24F 7/04; F24F 2007/0025

(57) ABSTRACT

In accordance with at least one aspect of this disclosure, a vent cover includes a body having a frame portion defining a first opening configured to align with an existing vent termination of a structure and a hood portion extending from a first end outward and away from the frame portion to a second end to cover the first opening. The hood portion includes a second opening defined at the second end configured to fluidly communicate ducting within the structure with ambient environment external to the structure through the first opening, the hood portion, and the second opening.

### TECHNICAL FIELD

The present disclosure relates to venting and vent covers and more particularly to multi-function vent covers.

### BACKGROUND

Conventional venting means, e.g., for allowing ingress or egress of air into a home or building, requires individual vent covers for intake versus exhaust, and depending on the location of the vent on the home. For example, current vent covers are purpose built for either intake or exhausting, and, they are purpose built and designed for their desired location, i.e., wall mount versus soffit mount. Accordingly, wall vent covers are not suitable for use on a soffit, while soffit vent covers are not suitable for use as a wall vent. Moreover, exhaust vents cannot be used as intake vents due to the different configurations in damper doors and pest guards. Because of this, homeowners typically need to buy numerous vents specific for each intake/exhaust location.

The conventional techniques have been considered satisfactory for their intended purpose. However, there is an ever-present need for improved systems and methods for improved venting means. This disclosure provides a solution for this need.

### SUMMARY

In accordance with at least one aspect of this disclosure, a vent cover includes a body having a frame portion defining a first opening configured to align with an existing vent termination of a structure and a hood portion extending from a first end outward and away from the frame portion to a second end to cover the first opening. The hood portion includes a second opening defined at the second end configured to fluidly communicate ducting within the structure with ambient environment external to the structure through the first opening, the hood portion, and the second opening.

The vent cover further includes a damper door configured to be mounted to the body within the hood portion to be positioned proximate the first opening or the second opening to selectively open and close access to the ducting through the first opening or the second opening and a pest guard configured to be mounted to the body within the hood portion proximate the second opening to prevent ingress of pests into the ducting through the second opening. In certain embodiments, the frame portion can include a plurality of mounting apertures configured for mounting the vent cover to the structure.

In certain embodiments, a collar can be included, configured to be mounted to the frame portion aligned with the first opening, on an opposite side of the frame portion as the hood portion. In certain embodiments, the first opening can include a thread on an inner diameter thereof, and the collar can include a thread on an outer diameter thereof, such that the collar is configured to be threaded into the first opening, maintaining proper code.

In certain embodiments, the pest guard can include a plurality of spaced apart bars configured to extend across the second opening. In certain embodiments, the pest guard can include a grate structure configured to substantially cover the second opening.

In certain embodiments, the hood portion can include a plurality of mounting apertures for mounting the damper door. For example, the plurality of mounting apertures can include a first set of mounting apertures defined in the hood portion proximate the first end for selectively mounting the damper door to the body in a first position, a second set of mounting apertures defined in the hood portion proximate the second end for selectively mounting the damper door to the body in a second position different from the first position, and a third set of mounting apertures defined in both the frame and the hood portion for selectively mounting the pest guard to the body.

In the first position the damper door can be configured prevent ingress to the ducting via the second opening. With the damper door mounted in the first position, the vent cover can be configured to be mounted to the structure as a soffit vent cover. In certain embodiments, with the damper door mounted in the first position, the damper door can be mounted to the hood portion to cover the second opening, and the pest guard can be mounted to an interior of the hood portion such that the damper door covers the pest guard with the damper door in a closed position.

In the second position, the damper door can be configured to prevent ingress to the ducting via the first opening. With the damper door mounted in the second position, the vent cover can be configured to be mounted to the structure as a wall vent cover. With the damper door mounted in the second position, the damper door can be mounted to an interior of the hood portion to cover the first opening, such that the hood portion covers the damper door (e.g., where the damper door is situated entirely within the hood portion).

In certain embodiments, the damper door can include a latch to secure the damper door in the closed position. In certain embodiments, the latch can be or include a magnetic latch, where a magnetic force of the magnetic latch can be selected such that the damper door is held in the closed position and exhaust flow from the structure is greater than the magnetic force, allowing the damper door to move to the open position with the exhaust flow.

In certain embodiments, a spacer ring can be included and configured to be mounted within the first opening to reduce a diameter of the first opening. A collar can be configured to be mounted within spacer ring aligned with the first opening, on an opposite side of the frame portion from the hood portion.

In accordance with at least one aspect of this disclosure, a vent cover kit can include a vent cover as described hereinabove, including a body as described above, a damper door configured to be mounted to the body within the hood portion to cover the first opening or the second opening to open and close access to the vent termination through the first opening or the second opening, a plurality of interchangeable pest guards configured to be selectively mounted to the body within the hood portion proximate the second opening to prevent ingress of pests through the second opening, and a collar configured to mate with the first opening of the vent cover. In certain embodiments, the kit can also include a plurality of fasteners configured for mounting the vent cover to the structure.

In certain embodiments, the plurality of interchangeable pest guards can include a first pest guard having a plurality of spaced apart bars configured to extend across the second opening, a second pest guard having a grate structure defining a plurality of grate openings of a first size, the grate structure configured to cover the second opening, and a third pest guard having a grate structure defining a plurality of grate openings of a second size, smaller than the first size, the grate structure configured to cover the second opening. In certain embodiments, the kit can further include a spacer ring configured to mate with the first opening to reduce a diameter of the first opening and a second collar configured to mate with the first opening and the spacer ring.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a schematic view of a structure in accordance with this disclosure, showing an embodiment of a universal vent cover installed on a structure in a plurality of configurations including a soffit configuration and a wall vent configuration;

FIG. 2 is a perspective view of the universal vent cover of FIG. 1 shown in a soffit exhaust configuration with a damper door shown in a closed position;

FIG. 3 is a perspective view of the universal vent cover of FIG. 1 shown in a soffit exhaust configuration with a damper door shown in an open position and with an embodiment of a pest guard installed in the vent cover;

FIG. 4 is a perspective view of the universal vent cover of FIG. 1 shown in a wall vent exhaust configuration with a damper door shown in a closed position and with an embodiment of a pest guard installed in the vent cover;

FIG. 5 is a perspective view of the universal vent cover of FIG. 1 shown in a wall vent exhaust configuration with a damper door shown in an open position;

FIG. 6 is a side elevation view of the universal vent cover of FIG. 1 shown with a collar attached for mounting the vent cover in a collar mount configuration;

FIG. 7 is a side elevation view of the universal vent cover of FIG. 1 shown with the collar removed for mounting in a flush mount configuration;

FIG. 8 is plan view an embodiment of a pest guard;

FIG. 9 is plan view another embodiment of a pest guard;

FIGS. 10a-10d show a perspective view of an embodiment of a collar and spacer ring; and

FIG. 11 is a schematic view of an embodiment of a universal vent kit.

### DETAILED DESCRIPTION

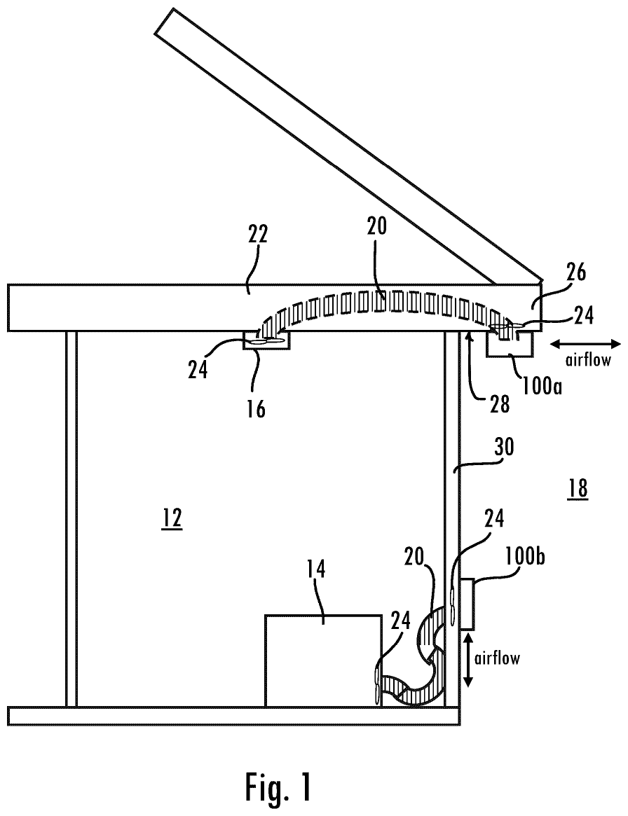

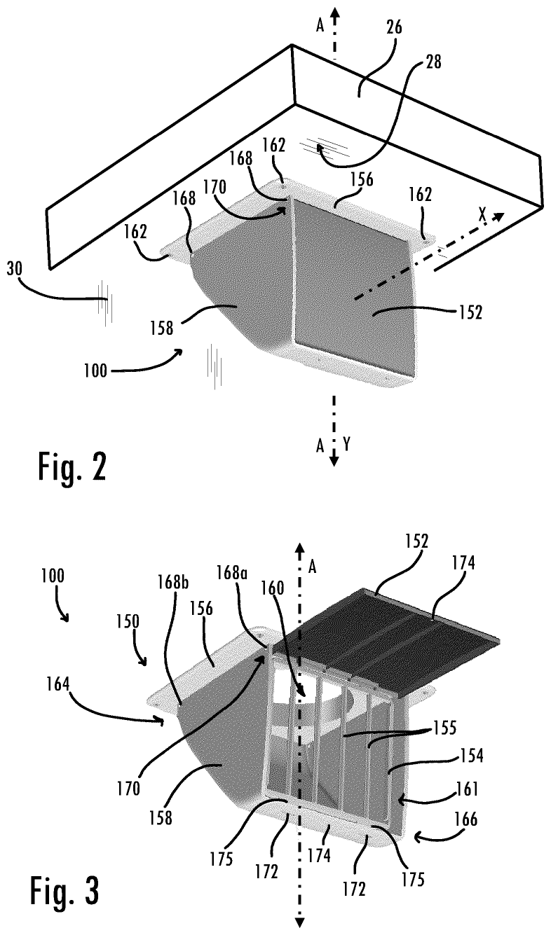

Reference will now be made to the drawings wherein like reference numerals identify similar structural features or aspects of the subject disclosure. For purposes of explanation and illustration, and not limitation, an illustrative view of an embodiment of a multi-function vent cover in accordance with the disclosure is shown in FIG. 1 and is designated generally by reference character 100. Other embodiments and/or aspects of this disclosure are shown in FIGS. 2-10.

FIG. 1 shows a schematic environmental view of an embodiment of structure 10, in this example a house. One or more rooms 12 in the house may include heat or steam generating appliances 14 such as showers or laundry machines (e.g., dryers). In such rooms, it is necessary to include exhaust fans 16 to exhaust steam and heat out of the room and to the exterior of the house 18 to avoid buildup of mold and mildew within the room 12. In this example, a room 12 is shown having a vent 16 in the ceiling and a clothes dryer 14. It is also important to have intake vents on the exterior of the house to allow fresh air to be brought into the house, e.g., via air handling system.

In FIG. 1, the ceiling vent 16 is shown connected to an exterior vent 100a on the exterior of the house 12. The ceiling vent 16 is connected to the exterior vent 100a via ducting 20 passing through a soffit 22. In a ceiling exhaust vent 16, an air mover 24 is included in the vent 16 to draw air out of the room 12 into the ducting 20, and out through the exterior soffit vent 100a. The exterior vent 100a in this configuration is referred to herein as a soffit vent configuration. In the soffit vent configuration, the exterior vent 100a is mounted to an overhanging feature 26 of the house 12, hanging down from the overhanging surface 28, and facing away from the exterior wall 30 of the house 12. The direction of airflow out of the vent 100a in this configuration is horizontal, as indicated in FIG. 1.

Still with reference to FIG. 1, another exterior vent 100b is shown, where the second exterior vent 100b is configured as an exterior wall mounted vent. In this configuration, the exterior vent 100b is herein referred to as an exterior wall vent. Here, the exterior wall vent 100b is shown connected to the clothes dryer 14 via ducting 20. The exterior wall vent 100b can be connected to any heat generating appliance, such as a furnace, a boiler, or the like, via ducting 20. The exterior wall vent 100b allows egress of the hot hair generated by the clothes dryer 14 or other heat generating appliance from the house to the atmosphere 18. When exhausting the heat generating appliances 14, an air mover 24 is typically included on the appliance 14 to push the hot air from the appliance 14 through the ducting 20 and out through the exterior wall vent 100b. In certain applications, an air mover 24 may be positioned proximate the exterior wall vent 100b (e.g., within the exterior wall 30) to aid in pushing the hot air out, or otherwise to draw the hot air away from the heat generating appliance 14.

In certain applications, a soffit vent 100a or an exterior wall vent 100b may be needed in an intake configuration, allowing ingress of air from the atmosphere into the house 10. For example, an air mover 24 can be included proximate the soffit vent 100a or the exterior wall vent 100b to draw air in from the atmosphere 18 and into the ducting 20 for distribution throughout the structure 10 by an air handling system.

Conventionally, a homeowner would need to buy individual vents for each of their intakes and exhausts, and for each of their soffits and wall exhausts. FIGS. 2-10 show an embodiment of a universal, or multi-function, vent 100 that can be used in multiple different configurations, allowing a homeowner to purchase an “all in one” solution for home venting. The multi-function vent cover 100 as described herein can be installed and used as an intake, an exhaust, on a soffit, or on a wall, and can be flush mount or collar mount. Additional features of the multi-function vent will be described for additional customization.

With reference now to FIGS. 2 and 3, an embodiment of the multi-function vent cover 100 is shown. In FIGS. 2 and 3, the multi-function vent cover 100 is shown in the soffit configuration for use as an exhaust vent, i.e. in a position like vent 100a shown in FIG. 1. As shown, the multi-function vent cover 100 includes a body 150, a damper door 152 (e.g., a backflow damper), and a pest guard 154. FIG. 2 shows the multi-function vent cover 100 with the damper door 152 closed. FIG. 3 shows the multi-function vent cover 100 with the damper door 152 open, with the pest guard 154 visible.

The body 150 defines a frame portion 156 and a hood portion 158. A first opening 160 is defined within the frame portion 156 circumferential to a vent axis A. The frame portion 156 defines a plurality of mounting apertures 162 for mounting the body 150 to a structure 10. When installed, the first opening 160 is configured to align with an opening in the structure 10 to fluidly communicate interior ducting 20 of the structure 10 to the atmosphere 18 on the exterior of the structure 10.

The hood portion 158 extends outward and away from the frame portion 156 from a first end 164 in a direction along the vent axis A, transitioning to a direction oblique to the vent axis A, the transitioning to extend in a direction perpendicular to the vent axis A to a second end 166, which defines a second opening 161. The first end 164 is proximate the frame portion 156, and the second end 166 is opposite the first end 164, such that the hood portion 158 has a profile shaped similar to a trimmed elbow.

The hood portion 158 can include a plurality of mounting apertures 168 at the first end for mounting the damper door 152 to the hood portion 158. The plurality of mounting apertures 168 for the damper door 152 includes a first set mounting apertures 168a defined at a junction 170 of the first end 164 and the second end 166 of the hood portion 158 and a second set of mounting apertures 168b is defined at the first end 164 of the hood portion 158, spaced apart from the first set 168a across the first opening 160. A plurality of mounting apertures 172 are defined in both the frame portion 156 and the second end 166 of the hood portion 158 for mounting the pest guard 154 to the vent cover 100 so the pest guard 154 can extend across the second opening 161. The pest guard 154 can include mounting tabs 175 for mating with the mounting apertures 172.

In the soffit configuration, the frame portion 156 is configured to be installed on a downward facing surface 28 of an overhanging portion 26 of the structure 10, e.g., as shown in FIG. 2. In this configuration, the vent axis A is arranged in a Y direction (e.g., up and down), and the second opening 161 faces outward, in an X direction (e.g., in and out), away from any exterior wall 30 of the structure 10. Here, the damper door 152 is mounted in the first set of mounting apertures 168a so that the damper door 152 opens outward and away from the hood portion 158, where the damper door 152 opens and closes access to the first opening 160 via the second opening 161. In certain embodiments, depending on the configuration of the structure at the location of the vent termination, the vent cover 100a can be installed so that the vent axis is perpendicular to the exterior wall 30 (i.e. in the X direction) and airflow is parallel to the exterior wall 30 (i.e., in the Y direction).

The pest guard 154 is mounted inside the hood portion 158 such that the damper door 152 and hood portion 158 cover and fully enclose the pest guard 154 with the damper door 152 in the closed position, such as shown in FIG. 2. The hood portion 158 extends away and down from the frame portion 156 such that the hood portion completely covers the first opening 160. With the damper door 152 close, the first opening 160 is not visible or accessible.

The configuration of the vent cover 100 in the soffit position allows the damper door 152 to be held in the closed position via gravity, however, in certain embodiments, a latching means 174 (e.g., a magnetic latch) can be included in the damper door 152 and/or the hood portion 158 to hold the damper door 152 shut and against the hood portion 158 when idle. Including a latching means 174 ensures the damper door stays closed when it is not in use, for example holding the damper door shut in high winds and preventing small animals or pests from entering the structure through the vent. In certain embodiments, the magnetic latch can be removeable (e.g., unscrewable) so that a use may remove the magnetic latch for applications where exhaust flow is not very strong, such as in a bathroom exhaust application.

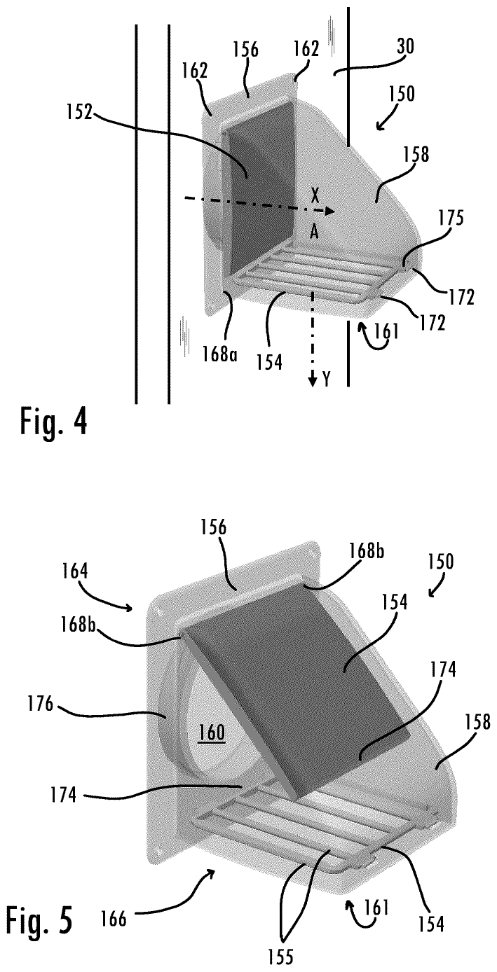

Referring now to FIGS. 4 and 5, the multi-function vent cover 100 is shown in the exterior wall vent configuration (e.g., 100b in FIG. 1). Here, the vent cover 100 is shown transparent to view inside the hood portion 158. In this configuration, the vent cover 100 is configured to be mounted to an exterior wall 30, where the vent axis A is arranged in an X direction (e.g., in and out) away from any exterior walls of the structure 10, and the second opening 161 faces downward, in a Y direction (e.g., up and down).

In the exterior wall vent configuration, the pest guard 154 is mounted within the hood portion 158 in the same manner as the soffit configuration. However, the damper door 152 is mounted inside the hood portion 158, obscured by the hood portion. In this configuration, the damper door 152 is mounted in the second set of mounting apertures 168b. The damper door 152 is mounted so that it opens outward and away from the frame portion 156, where the damper door 152 opens and closes access to the first opening 160. In the exterior wall vent configuration, the damper door 152 can be held shut via gravity when idle, or by latching means 174, such as a magnetic latch included in the damper door 152 and/or the frame portion 156.

The damper door 152 is configured to be detachably mounted within either the first set of mounting apertures 168a or the second set of mounting apertures 168b to easily transition the multi-function vent between the soffit or wall vent configurations, e.g., switching from the configuration of FIG. 2 to the configuration of FIG. 4. The damper door 152 and pest guard 154 are configured to be held in place within the hood portion via interference fit, so no tools are required to assemble or disassembly the vent cover 100 or change the configuration of the vent cover 100.

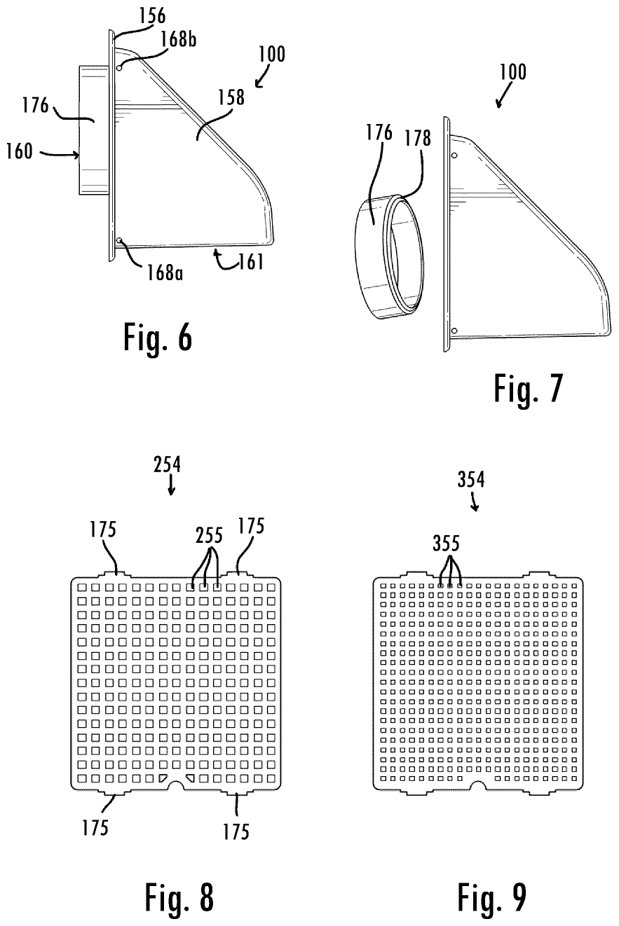

Additional customizations for the multi-function vent are shown in FIGS. 6-9. In FIGS. 6 and 7, a collar 176 is shown. The collar 176 can include threading 178 to allow the collar 176 to be threaded to the frame portion 156 aligned with the first opening 160. The collar 176 being selectively mountable with the frame portion 156 allows the multi-function vent cover 100 to be flush mounted or collar mounted depending on the application desired by the user. The collar 176 is configured and adapted to fit over an existing code compliant ducting termination (not shown), so the existing ducting is situated inside the collar 176. The threading 178 can be such that only a quarter turn is needed to securely thread the collar 176 to the frame portion 158. FIG. 6 shows the collar 176 threaded to the frame portion 156 while FIG. 7 shows the collar 176 detached from the frame portion 156.

As shown in FIGS. 8 and 9, additional embodiments of a pest guard 154 are shown. The pest guard 154 shown in FIGS. 2-5 is configured for when the multi-function vent is being used in an exhaust application. In such applications, the pest guard 154 need only keep out larger pests like birds, rodents, or other small animals that make nests inside ducting 20. Since the damper door 152 is used in the exhaust application, the pest guard 154 does need to keep out smaller pests such as insects or debris such as leaves or sticks, because the damper door 152 will serve this function. When the exhaust fans are idle, the damper door 152 remains shut, so the pest guard 154 need only prevent larger pests from reaching the damper door 154. When actively exhausting, the heat and airflow should naturally keep the smaller pests such as insects away from damper door 152 and first opening 161.

However, when the multi-function vent cover 100 is used in an intake application, the damper door 152 is removed entirely. Therefore, the openings of the pest guard 152 should be much smaller, preventing the smaller pests and debris from reaching the first opening 161, or from being drawn in with the fresh air being pulled through the intake. In exhaust applications, the pest guard 154 can include a plurality of spaced apart bars 155. In the intake application, the pest guards 254, 354 shown in FIGS. 8 and 9 can include a grate structure. The openings 255, 355 defined in the grate structure are much smaller than the opening defined by the spaced apart bars 154. Embodiments of the pest guards 254, 354 can have varying sized openings, for example, the holds 355 of pest guard 354 are smaller than the openings 255 of pest guard 254 as shown in FIGS. 8 and 9.

It is also possible, however, for the grate structures 254, 354 to be used in an exhaust configuration as well, for example when exhausting bathroom vents, to prevent bees or other nesting insects from making hives or nests within the hood portion of the vent cover. Thus, the pest guards 154, 254, 354 can be interchangeable so the user can customize the vent cover 100 for its desired use, but also based on their location and the pests or insects they typically see in their geographic area.

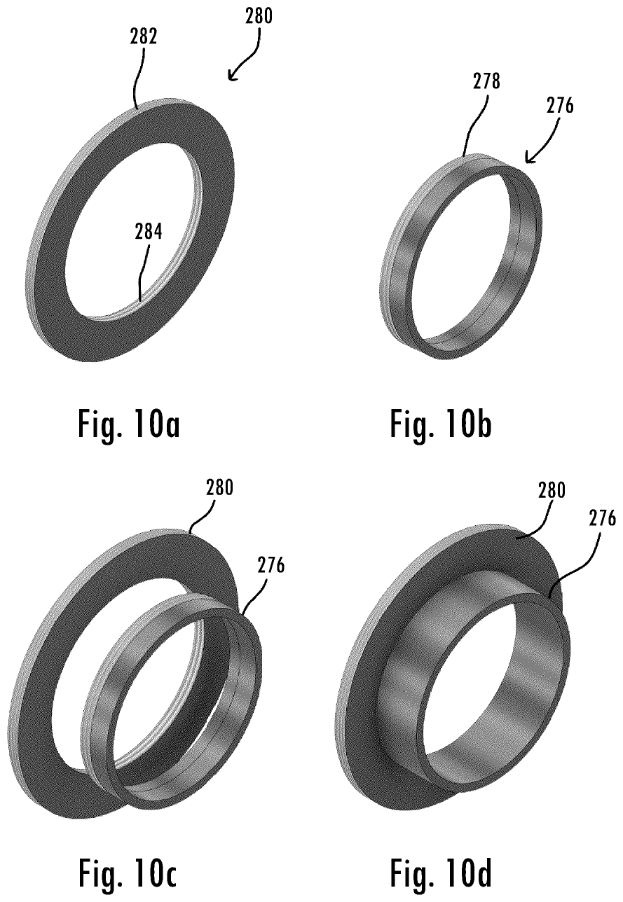

Shown in FIG. 10a-10d, an embodiment of another customization is shown. Typically, dryer vent exhaust ducting and terminations are different sizes than that of intake vents, or bathroom exhaust vent termination and ducting. For example, bathroom exhaust and general intake vents terminations and ducting are typically smaller in diameter than dryer exhaust ducting and terminations. Specifically, dryer vent ducting and terminations are 4 inches in diameter, while ducting and terminations for bathroom vent exhausts and intake vents generally are 3 inches in diameter, which is often dictated by code.

FIG. 10a shows a spacer ring 280, that can be installed within the first opening 160 of the vent cover 100. The spacer 280 can include an external thread 282 to thread into the first opening of 160 of the vent cover 100. When installed, the spacer ring 280 will decrease the diameter of the first opening 160, for example from a 4-inch diameter to a 3-inch diameter. This will allow the vent cover 100 to be used in a flush mount application with a smaller opening, such as a 3-inch ducting or termination. Additionally, as shown in FIG. 10b, a second collar 276 is shown having an external threading 278 configured to thread into internal threads 284 of the spacer ring 280. When installed, the second collar 276 allows for a collar mount application with a smaller opening, such as a 3-inch collar mount application. FIGS. 10c and 10d show the installation of the second collar 276 into the spacer ring 280. While threaded connection between the collar and the vent cover is described, other means of attaching the collar and spacer ring are contemplated herein including, friction fit, or ball/detent snapping means, or the like.

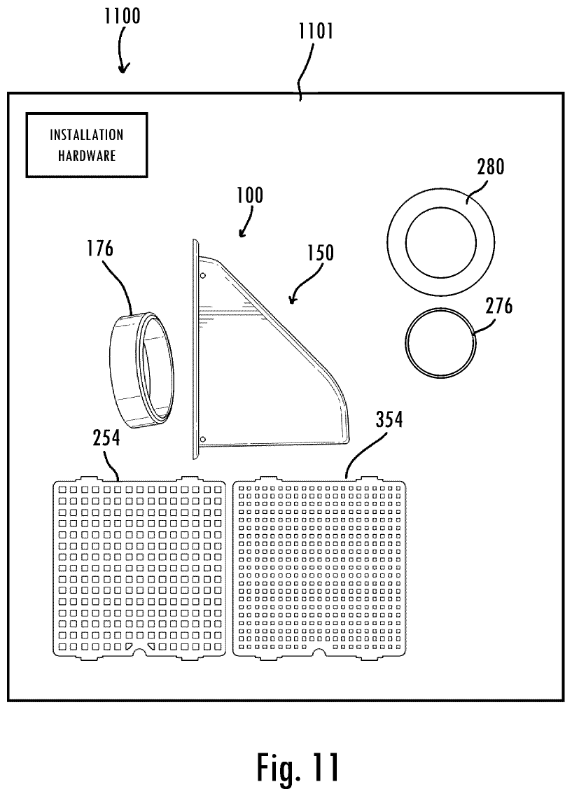

FIG. 11 shows an embodiment of a kit 1100. Each of the components described herein can be included in a single package 1101 as a kit. This allows a user to purchase a single kit 1100 with 16 different possible configurations of the vent cover 100. The 16 configurations include a four-inch collar mounted soffit exhaust (e.g., as shown in FIG. 2), a four-inch collar mounted wall exhaust (e.g., as shown in FIG. 3), a four-inch collar mounted soffit intake, a four-inch collar mounted wall intake, a four-inch flush mount wall exhaust, a four-inch flush mount soffit exhaust, a four-inch flush mount wall intake, a four-inch flush mount soffit intake, and each of the above recited configurations with a three-inch diameter.

Embodiments of the multi-function vent cover 100 are configured such that the backflow damper 152 can easily be changed within the cover 100 from the wall mount position to the soffit position without the need for any tools or additional parts. The vent cover 100 is configured to allow the backflow damper 152 to be easily removed and used as an intake cover in both the soffit and wall mount position. The included pest guard 154, 254, 354 can remain in the same position for both soffit and wall use; for soffit use, the guard will be concealed behind the backflow damper, while for wall use, the guard will be visible at the bottom.

Embodiments of the kit 100 include each of the following components: the vent cover 100, a plurality of pest guards 154, 254, 354 with varying hole sizes, a damper door 152, and installation hardware (e.g., fasteners or the like) for installing the vent cover 100 to the structure 10. Within the package 1001, each of the components can be disassembled from one another so that a user can choose how they wish to set up the vent cover for their particular needs. In certain embodiments, such as shown in FIG. 10, the vent cover can come preassembled into any one of the eight configurations, such as a flush mounted wall exhaust, where the damper door 152 and pest guard 154 are shown obscured by the vent cover 100.

The interchangeability of the components also allows for a user to repurpose the vent cover 100 into new applications, for example if a remodel is done and the vent cover 100 is no longer needed in its original location. The vent cover 100 described herein allows for improved functionality and customization of vent covers so that users need to only buy a single package that includes all components for eight different venting configurations.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “r” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A vent cover, comprising:
a body including:
a frame portion defining a first opening configured to align with an existing vent termination of a structure;
a hood portion extending from a first end outward and away from the frame portion to a second end to cover the first opening, the hood portion including a second opening defined at the second end of the hood portion configured to fluidly communicate ducting within the structure with ambient environment external to the structure through the first opening, the hood portion, and the second opening;
a damper door configured to be mounted to the body within the hood portion to be positioned proximate the first opening or the second opening to selectively open and close access to the ducting through the first opening or the second opening; and
a pest guard configured to be mounted to the body within the hood portion proximate the second opening to prevent ingress of pests into the ducting through the second opening.

2. The vent cover of claim 1, further comprising a collar configured to be mounted to the frame portion aligned with the first opening, on an opposite side of the frame portion as the hood portion.

3. The vent cover of claim 2, wherein the first opening includes a thread on an inner diameter thereof, and the collar includes a thread on an outer diameter thereof, such that the collar is configured to be threaded into the first opening.

4. The vent cover of claim 1, wherein the pest guard includes a plurality of spaced apart bars configured to extend across the second opening.

5. The vent cover of claim 1, wherein the pest guard includes a grate structure configured to substantially cover the second opening.

6. The vent cover of claim 1, wherein the hood portion includes a plurality of mounting apertures for mounting the damper door including a first set of mounting apertures defined in the hood portion proximate the first end for selectively mounting the damper door to the body in a first position, a second set of mounting apertures defined in the hood portion proximate the second end for selectively mounting the damper door to the body in a second position different from the first position, and a third set of mounting apertures defined in both the frame and the hood portion for selectively mounting the pest guard to the body.

7. The vent cover of claim 6, wherein in the first position such the damper door is configured prevent ingress to the ducting via the second opening.

8. The vent cover of claim 7, wherein with the damper door mounted in the first position, the vent cover is configured to be mounted to the structure as a soffit vent cover.

9. The vent cover of claim 8, wherein with the damper door mounted in the first position, the damper door is mounted to the hood portion to cover the second opening, and wherein the pest guard is mounted to an interior of the hood portion such that the damper door covers the pest guard with the damper door in a closed position.

10. The vent cover of claim 6, wherein in the second position, the damper door is configured to prevent ingress to the ducting via the first opening.

11. The vent cover of claim 10, wherein with the damper door mounted in the second position, the vent cover is configured to be mounted to the structure as a wall vent cover.

12. The vent cover of claim 11, wherein with the damper door mounted in the second position, the damper door is mounted to an interior of the hood portion to cover the first opening, such that the hood portion covers the damper door.

13. The vent cover of claim 1, wherein the damper door includes a latch to secure the damper door in the closed position.

14. The vent cover of claim 13, wherein the latch includes a magnetic latch, wherein a magnetic force of the magnetic latch is such that the damper door is held in the closed position and exhaust flow from the structure is greater than the magnetic force, allowing the damper door to move to the open position with the exhaust flow.

15. The vent cover of claim 1, wherein the frame portion includes a plurality of mounting apertures configured for mounting the vent cover to the structure.

16. The vent cover of claim 1, further comprising a spacer ring configured to be mounted within the first opening to reduce a diameter of the first opening, and a collar configured to be mounted within spacer ring aligned with the first opening, on an opposite side of the frame portion from the hood portion.

17. A vent cover kit, comprising:
a vent cover having:
a body including:
a frame portion defining a first opening configured to align with a vent termination of a structure; and
a hood portion extending from a first end outward and away from the frame portion to a second end to cover the first opening, the hood portion including a second opening defined at the second end of the hood portion configured to fluidly communicate ducting within the structure with ambient environment external to the structure through the first opening, the hood portion, and the second opening;
a damper door configured to be mounted to the body within the hood portion to cover the first opening or the second opening to open and close access to the vent termination through the first opening or the second opening;
a plurality of interchangeable pest guards configured to be selectively mounted to the body within the hood portion proximate the second opening to prevent ingress of pests through the second opening; and
a collar configured to mate with the first opening of the vent cover.

18. The kit of claim 17, further comprising:
a spacer ring configured to mate with the first opening to reduce a diameter of the first opening; and
a second collar configured to mate with the first opening and the spacer ring.

19. The kit of claim 17, wherein the plurality of interchangeable pest guards include:
a first pest guard having a plurality of spaced apart bars configured to extend across the second opening;
a second pest guard having a grate structure defining a plurality of grate openings of a first size, the grate structure configured to cover the second opening; and
a third pest guard having a grate structure defining a plurality of grate openings of a second size, smaller than the first size, the grate structure configured to cover the second opening.

20. The kit of claim 17, further comprising a plurality of fasteners configured for mounting the vent cover to the structure.
